(19) United States
(12) Patent Application Publication
(10) Pub. No.: US 2024/0305021 A1
(43) Pub. Date: Sep. 12, 2024

(54) CONNECTOR ASSEMBLY FOR CONNECTION TO A VEHICLE ELECTRICAL GROUND

(71) Applicant: HOPKINS MANUFACTURING CORPORATION, Emporia, KS (US)

(72) Inventors: Aaron C. Thomsen, Burlington, KS (US); William K. Blalock, Emporia, KS (US); Douglas G. Guenther, St. Charles, IL (US)

(73) Assignee: HOPKINS MANUFACTURING CORPORATION, Emporia, KS (US)

(21) Appl. No.: 18/598,614

(22) Filed: Mar. 7, 2024

Related U.S. Application Data
(60) Provisional application No. 63/488,868, filed on Mar. 7, 2023.

(51) Int. Cl. H01R 11/05; B60R 16/06; H01R 4/30; H01R 4/34; H01R 4/70

(52) U.S. Cl. CPC H01R 11/05; B60R 16/06; H01R 4/304; H01R 4/34; H01R 4/70; H01R 2201/26

(57) ABSTRACT

A connector assembly for providing electrical connection from an electrical device ground wire to a vehicle chassis ground comprises a connection to the electrical device ground wire and a surface connector. a surface connector configured to attach to a vehicle chassis, wherein the surface connector comprises an insulating cover and conductive contact points within the insulating cover configured to selectively protrude through the insulating cover and make contact with the vehicle chassis when the connector assembly is secured to the vehicle chassis. Once installed the insulating cover creates a seal around the contact points to protect the connector assembly from oxidation.

### CLAIM OF PRIORITY TO PRIOR APPLICATION

This application claims the benefit of the filing date of U.S. Provisional Application, Ser. No. 63/488,868, filed on Mar. 7, 2023, entitled “Connector Assembly for Connection to a Vehicle Electrical Ground”. By this reference the entire disclosure, including the claims and drawings, of U.S. Provisional Application, Ser. No. 63/488,868 is hereby incorporated into the present disclosure as though now set forth in its entirety.

### BACKGROUND OF THE INVENTION

1. Field of the Invention

The present invention relates generally to the electrical connector assemblies that connect to the electrical ground of a vehicle, specifically an assembly that resists corrosion and wear in operation.

### 2. Description of Related Art

Connector assemblies that connect to a vehicle chassis or electric power distribution enclosures to provide an electrical ground connection typically include a ring connector that connects to a grounding wire and a washer that connects to the chassis or enclosure. In conventional connector assemblies, water and road salt, among other materials, come into contact with the connector and oxidize the exposed mating surfaces of the ring connector and washer which increase the impedance of the electrical connection and may lead to loss of operation of any electrical devices connected to the connector assembly. A loss of operation can result in not only the need to replace the connector assembly but may be a danger if electrical features such as brake or signal lights are not operational.

### BRIEF SUMMARY OF THE INVENTION

Embodiments of the current invention solve the above-mentioned problems and provide a distinct advance in the art of providing an electrical connection from a ground wire to a vehicle's electrical ground or electric ground of an electric power distribution enclosure. Specifically, embodiments of the current invention provide a connector assembly which forms a seal at the point of contact between the connector assembly and a vehicle chassis or the enclosure. The seal prevents oxidation of the connector assembly and chassis surfaces or enclosure surfaces.

In one embodiment, the connector assembly broadly comprises a wire connector, a an insulating cover, and a surface connector. The wire connector is configured to receive the electrical device ground wire. The surface connector is coupled to the wire connector and configured to attach to the vehicle chassis with a fastener. The insulating cover can be molded from rubber or from several other materials with sufficient insulating properties. The surface connector is made from a conductive material includes protruding attachment points. The insulating cover substantially covers the surface connector including the protruding attachment points when unattached to the chassis. The protruding attachment points of the surface connector are shaped to pierce through the insulating cover and contact the conductive surface of the chassis when the fastener is inserted through the surface connector and secured to the chassis. Once the fastener is tightened with the proper torque, the connector assembly is secured to the chassis and able to conduct electricity through the protruding attachment points, and the insulating cover seals the surrounding area of the contact points.

In other embodiments, the connector assembly is substantially similar in design and function. In alternative embodiments, the protruding attachment points of the conductive mounting plate are geometrically designed to minimize damage to the device and the chassis in the event of overtightening of the fastener during installation. The attachment points in some embodiments are thicker to resist damage to connector assembly when tightening the fastener while securing the connector assembly to the chassis. Other embodiments have tabs between the attachment points to distribute the force of installation of the connector assembly

Additional embodiments of the connector assembly are designed to clamp to an edge of the chassis of a vehicle without any screws or fasteners. In this embodiment, the connector assembly broadly comprises an insulating cover and a surface connector. The surface connector is coupled to the ground wire and configured to attach to an edge of the vehicle chassis of sufficient thickness. The surface connector takes the shape similar to that of a clamp with contact points that protrude inwards on one end of the clamp. The surface connector is further configured to independently secure both sides of the edge of the vehicle without any additional fasteners or screws. The insulating cover protects the area in which the surface connector and wire are coupled in addition to the protruding contact points on the surface connector. The protruding attachment points of the surface connector are designed to pierce through the insulating cover when it is clamped to the edge of a vehicle chassis and make contact with the conductive surface of the chassis. The insulating cover seals to the surrounding area of the contact points when properly installed.

In yet another embodiment, the connector assembly broadly comprises a wire, a casing, a washer, an inner insulating ring and an outer insulating ring. The case is made of a conductive material that will not rust. The ground wire is coupled to the star washer within the case. The case includes an upper surface, an opposing lower surface, a circumferential outer edge, and a spaced apart circumferential inner edge defining a central opening configured to receive a fastener which attaches the surface connector to the chassis of the vehicle. In this embodiment, the inner insulating ring and outer insulating ring are appropriately sized O-rings. The outer insulating ring covers a portion of the upper surface, the outer edge, and a portion of the lower surface of the conductive disc. The inner insulating ring is positioned in contact with the lower surface of the case and includes an inner edge aligned with the inner edge of the case. The inner insulating ring, a portion of the lower surface of the conductive disc, and the outer insulating ring form a hermetically sealed chamber with the chassis when the surface connector is attached to the electric power distribution enclosure. In another similar embodiment, instead of using premanufactured O-rings to insulate the electrical connection. The case is manufactured to include inlets in which a liquid sealant is injected into after installation of the connector assembly. Once hardened, the liquid sealant provides a hermetically sealed chamber with the chassis.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

The disclosure, including descriptions, drawings, and claims, describes one or more embodiments of the invention. Many other features, objects, and advantages of the invention will be apparent to one of ordinary skill in the art from the disclosure. Given the disclosure, especially in light of the prior art, it is another object of the invention to improve upon, and overcome the inefficiencies, limitations, and constraints of, the prior art.

### BRIEF DESCRIPTION OF THE DRAWINGS

FIGS. 1A & 1B show a top and bottom perspective of a preferred embodiment of the connector assembly

FIGS. 2A & 2B show a top and bottom perspective of a preferred embodiment of the connector assembly with a transparent insulating cover.

FIG. 3 is a side perspective of a preferred embodiment of the connector assembly secured to a chassis and secured with a fastener.

FIG. 4 is a top perspective of a preferred embodiment of the connector assembly secured to a chassis and secured with a fastener with a transparent insulating cover.

FIG. 5 is a side perspective of a preferred embodiment of the connector assembly prior to being secured to the chassis of a vehicle.

FIG. 6 is a side perspective of a preferred embodiment of the connector assembly after being secured to the chassis of a vehicle.

FIGS. 7A & 7B show a top and bottom perspective view of an alternate embodiment of the connector assembly.

FIGS. 8A & 8B show a top and bottom perspective view of an alternate embodiment of the connector assembly with tabs between the conductive contact points.

FIGS. 9A & 8B show top perspective views of an alternate embodiment of the connector assembly that clamps to the side of a vehicle chassis without the use of additional fasteners.

FIGS. 10A & 10B show side perspective views of an alternate embodiment that clamps to the side of a vehicle chassis without the use of additional fasteners.

FIGS. 11A & 11B show top perspective views of an alternate embodiment that utilizes a washer surrounded by inner and outer O-rings.

FIGS. 12A & 12B show bottom perspective views of an alternate embodiment that utilizes a washer surrounded by inner and outer O-rings.

FIGS. 13A & 13B show top perspective views of an alternate embodiment that utilizes a washer sealed with a liquid sealant.

### DETAILED DESCRIPTION

Preferred embodiments of the present invention involve a connector assembly for connection to a vehicle electric ground which forms a protective seal at the point of contact between the connector assembly and a vehicle chassis or the enclosure. Embodiments will provide protection from water, road salt, and other oxidizing materials which may come into contact with the connector assembly. Such oxidation may lead to loss of operation of any electrical devices connected to the connector assembly.

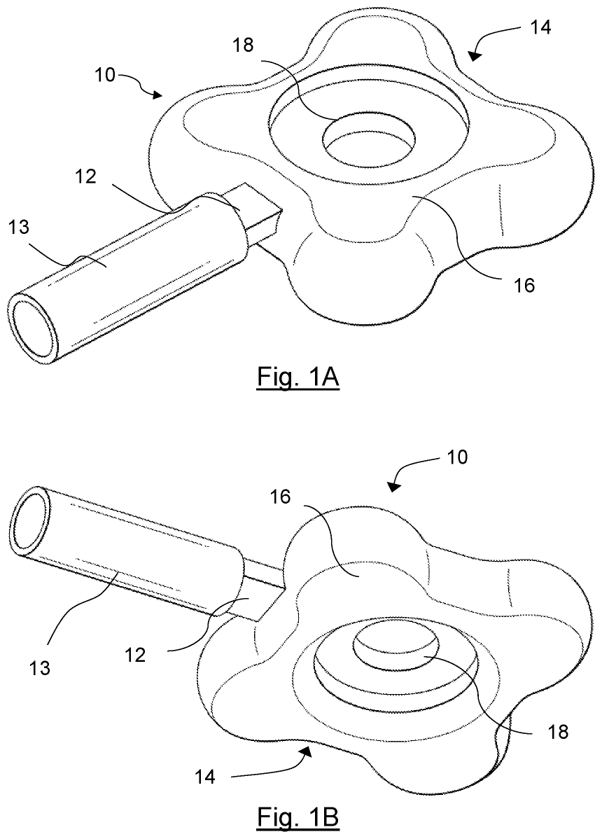

Turning to FIGS. 1A & 1B, there is shown a top and bottom perspective, respectively, of a preferred embodiment of the connector assembly 10. The connector assembly comprises a wire connector 12, a surface connector 14, and an insulating cover 16. The wire connector 12 is configured to receive the electrical device ground wire 13 directly or indirectly. The surface connector is designed to be secured through an interior socket 18 to a surface.

The surface connector 14 is coupled to the wire connector 12 is made from a conductive material. The insulating cover 16 can be molded from rubber or from any number of other materials with similar properties to neatly fit around the surface connector 16 and to protect from oxidation. The insulating cover 14 surrounds the surface connector 16 substantially, leaving only a small perimeter around the interior socket 18 exposed when unattached.

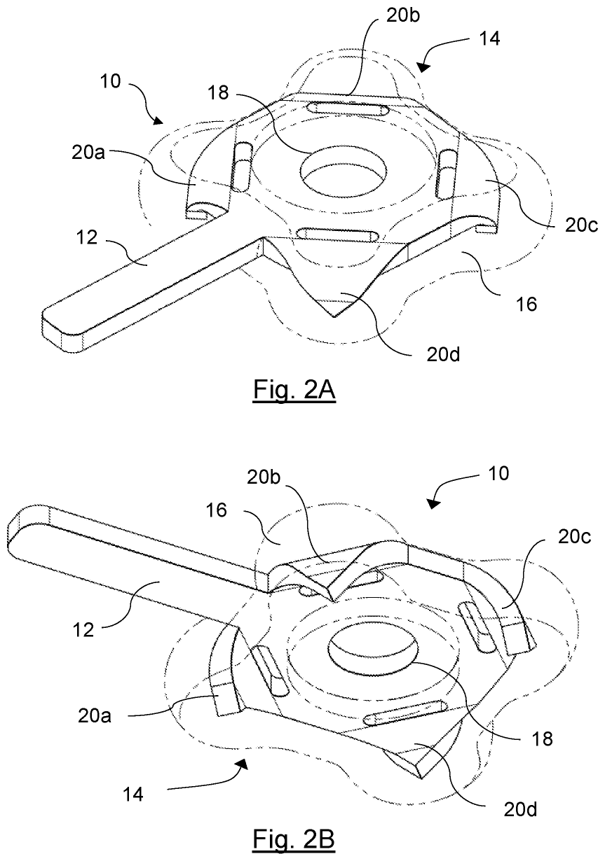

Turning to FIGS. 2A & 2B, which shows a top and bottom perspective, respectively, of a preferred embodiment of the connector assembly 10 with a transparent insulating cover 14. The surface connector 14 includes several protruding attachment points 20a-20d and an interior socket 18 allowing the surface connector 14 to be fastened to a surface. The protruding attachment points 20a-20d of the surface connector are shaped to pierce through the insulating cover 16 and contact the conductive surface of the chassis when secured to a surface. Once attached with the proper torque, the connector assembly 10 is secured to and able to conduct electricity through the protruding attachment points 20a-20d with the rest of the mounting plate protected from corrosion by the insulating cover.

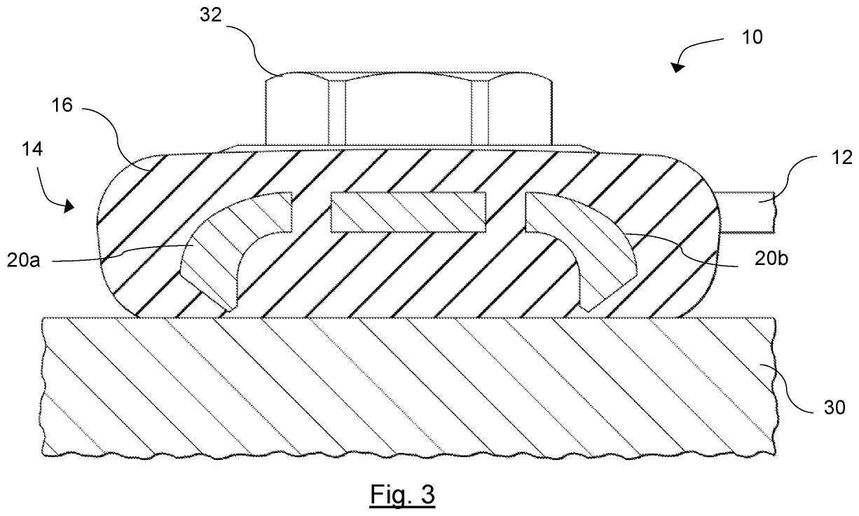

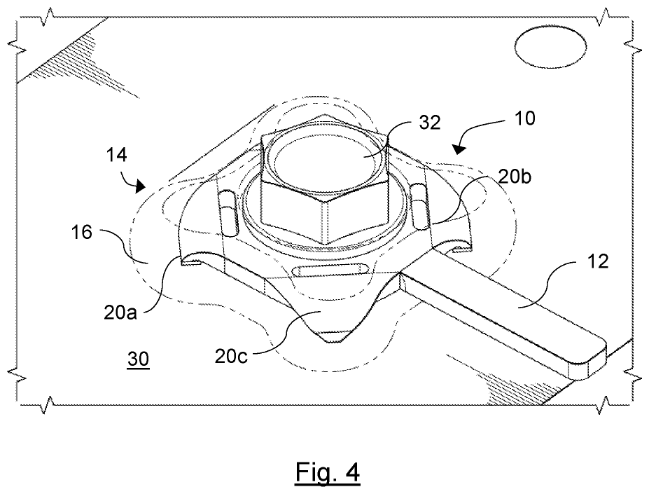

Shown in FIG. 3, which is a side perspective of a preferred embodiment of the connector assembly 10 secured to a chassis of a vehicle 30 and secured with a fastener 32. The insulating cover 16 forms a seal around the surface connector 14 except the areas the protruding attachment points 20a & 20b contact the chassis of a vehicle. This allows for a protected connection from the wire connector 12 that travels through the protruding attachment points 20a & 20b to the conductive surface of the chassis 30. Shown in FIG. 4 is a top perspective of a preferred embodiment of the connector assembly 10 secured to a chassis 30 and secured with a fastener 32 with a transparent insulating cover 16. The connection between the surface connector 14 through the protruding attachment points 20a-20c the tips of which have pierced the insulating cover 16 to form a protected connection with the chassis 30.

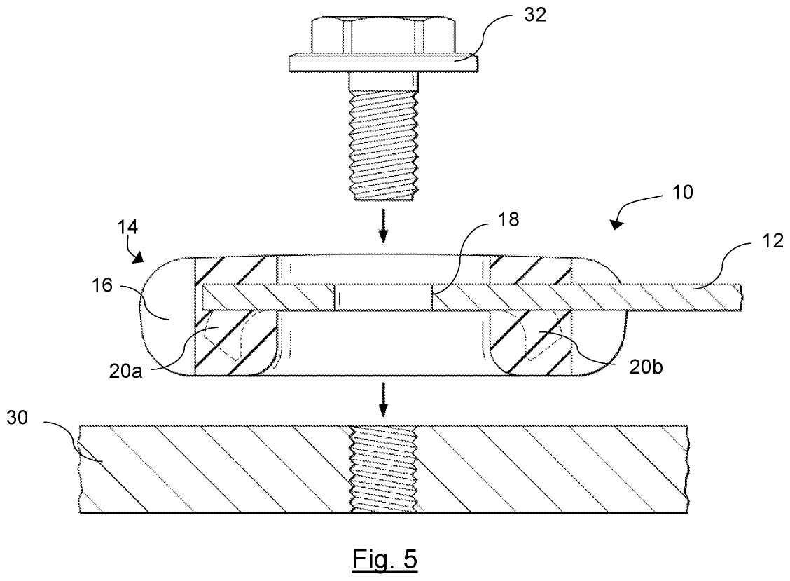

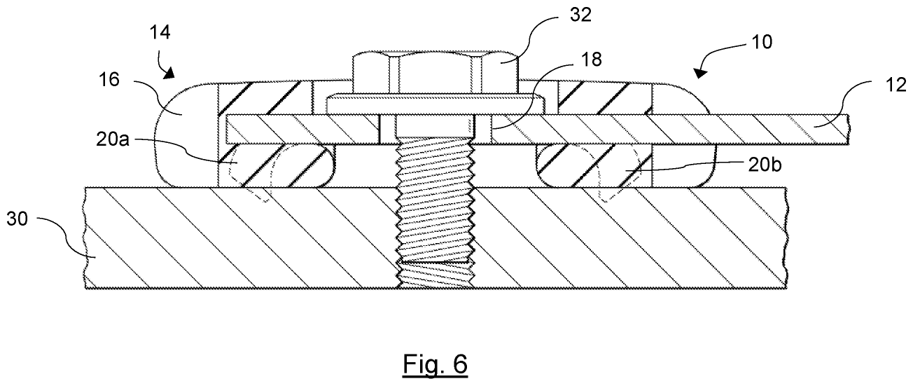

Shown in FIG. 5 is a side perspective of a preferred embodiment of the connector assembly 10 prior to being secured to the chassis of a vehicle 30. Before the fastener 32 is secured through the socket 18 of the surface connector 14, the protruding attachment points 20a & 20b have not yet extended beyond the insulating cover 16. As can be seen in FIG. 6, which is a side perspective of a preferred embodiment of the connector assembly 10 after being secured to the chassis of a vehicle 30. The fastener 32 is now tightened through the socket 18 of the surface connector 14 and the protruding points 20a & 20b are in contact with the chassis 30. Meanwhile, the insulating cover 16 forms a protective seal around those connections.

Those skilled in the art will recognize that the preferred embodiment provided above is for illustrative purposes and many different materials or configurations can be utilized. For example, the protruding attachment points 20 are shown above as sharp points but in some non-limiting examples shown below, they can be various geometries and quantities and still achieve a similar result.

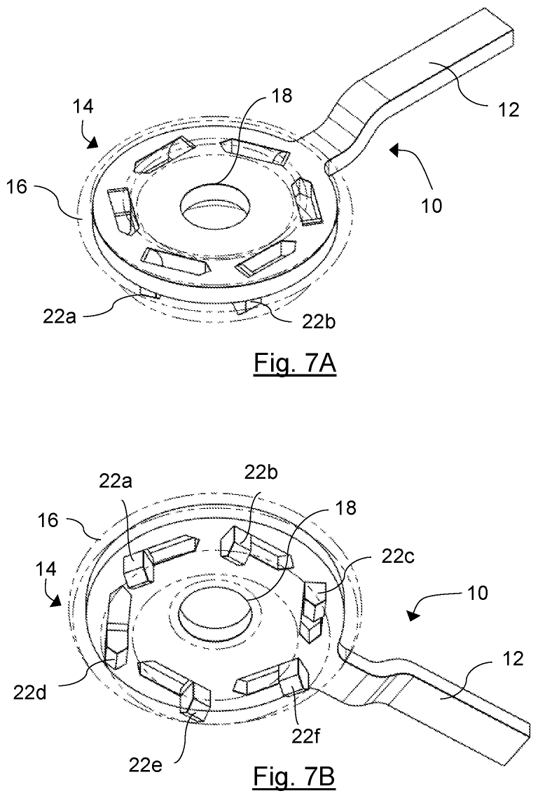

Turning now to FIGS. 7A & 7B, which show a top and bottom perspective view, respectively, of an alternate embodiment of the connector assembly 10. This alternative embodiment functions similarly to the preferred embodiment, the vehicle ground connection is made through a wire connector 12 that is coupled to the surface connector 14 and the connector assembly is secured through the socket 18. However, as can be seen through the transparent insulating cover 16, the protruding points 22a-22f of the surface connector 14 can be of various geometries. In this non-limiting example, the protruding points 22a-22f of the alternate embodiment are shown to be less of a sharp point and thicker than the protruding points 20 of the preferred embodiment. This is so the protruding points 22a-22f are more capable of resisting the force of over tightening when the connector assembly 10 is installed to the chassis of a vehicle 30 which can damage the functionality of the connector assembly 10.

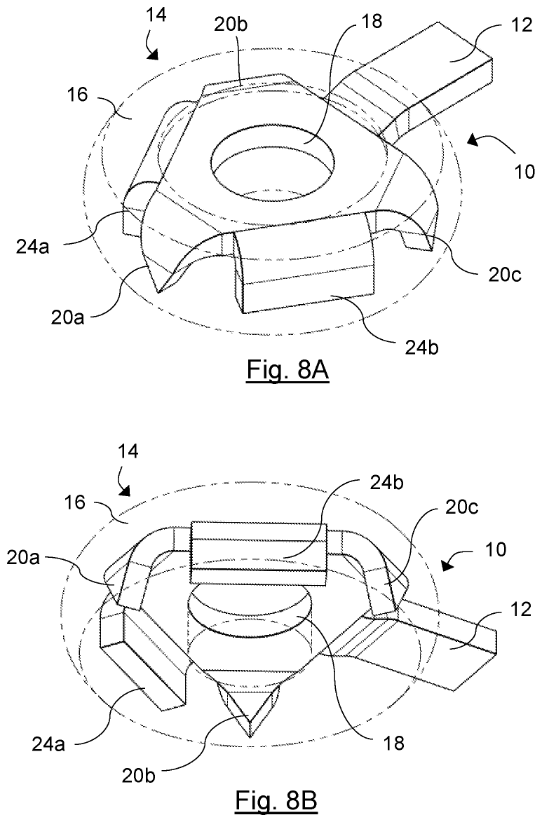

Shown in FIGS. 8A & 8B, which are a top and bottom perspective view, respectively, of an alternate embodiment of the connector assembly 10. As can be seen through the transparent insulating cover 16, the surface connector 14 is coupled to the wire connector 12 and has both tabs 24a & 24b and protruding conductive points 20a-20c. The tabs 24a & 24b help alleviate the force of overtightening a fastener 32 through the socket 18 of the surface connector 14 by providing a wider surface area.

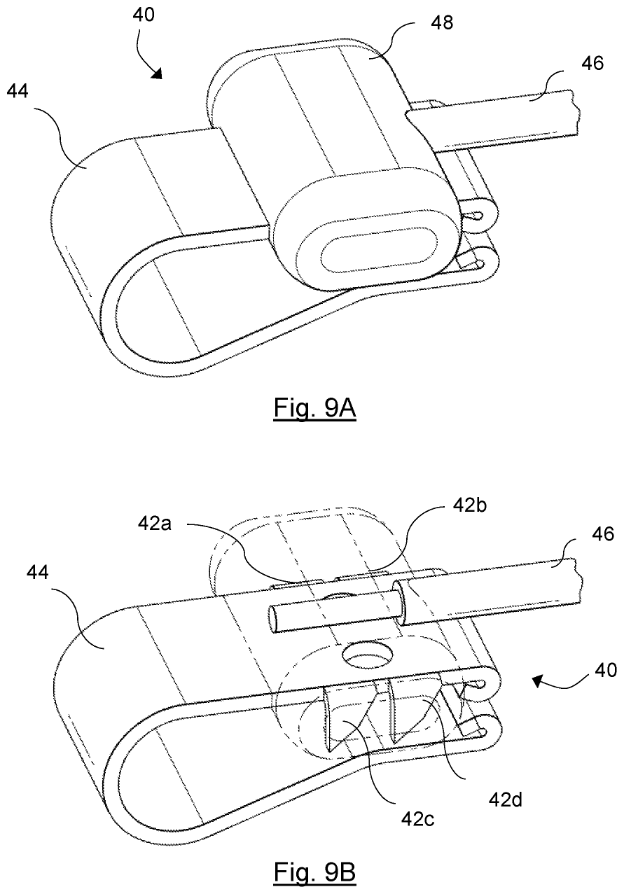

Turning to FIG. 9A & 9B, which are top perspective views of an alternate embodiment of the connector assembly 40 that clamps to the side of a vehicle chassis 30 without the use of additional fasteners. The alternate embodiment has a surface connector 44 that takes a clamp-like shape. It is coupled to the ground wire 46 and the connection between the wire and the surface connector 44 is protected by an alternate embodiment of the insulating cover 48. Also, within the insulating cover 48, are contact points 42a-42d.

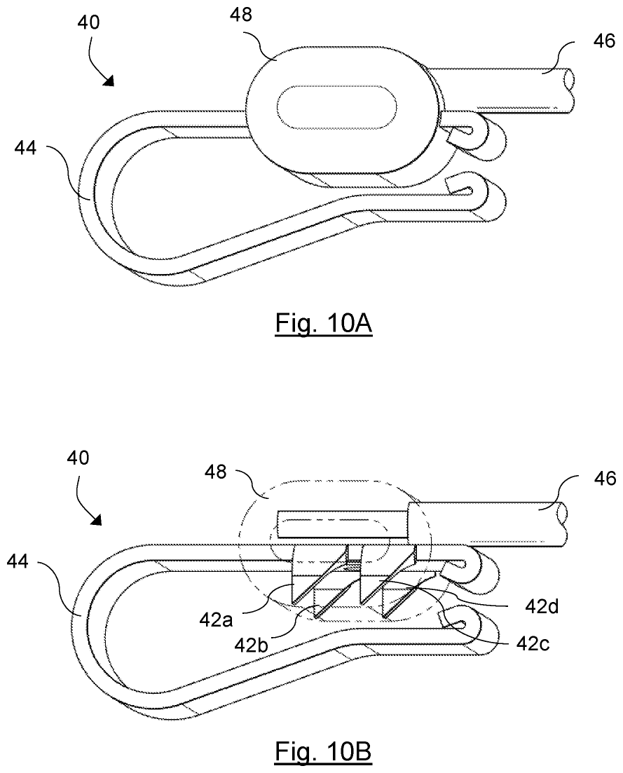

Shown in FIGS. 10A & 10B are side perspective views of the same alternate embodiment of the connector assembly 40. The contact points 42a-42d of the connector assembly 44, the ground wire 46, and the insulating cover 48 can be seen.

The alternate embodiment of the connector assembly 40 is designed to attach, without the use of fasteners or screws, to the metal side of the chassis of the vehicle 30 of sufficient thickness. The surface connector 44 grips both sides of the metal securely. The contact points 42a-42d of the surface connector 44 pierce through the insulating cover 48 and make contact with the metal surface when attached. The insulating cover 48 creates a seal around the contact points 42a-42d to protect the area from debris and oxidation.

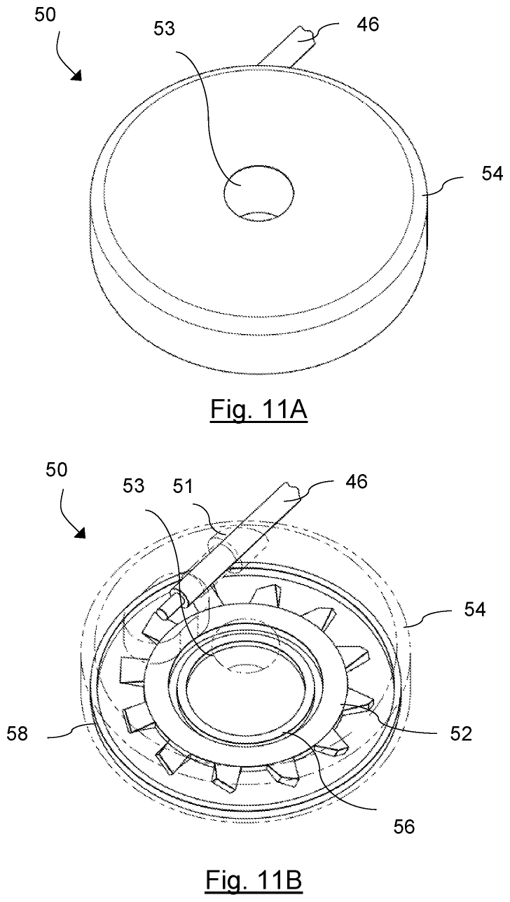

Turning now to FIGS. 11A & 11B, which show top perspective views of another alternate embodiment of the connector assembly 50 that utilizes a conductive surface connector 54. Also seen are the ground wire 46, and a channel 51 through the surface connector 54, conducive disk or washer 52, an interior socket 53, an inner insulating ring 56, and an outer insulating ring 58.

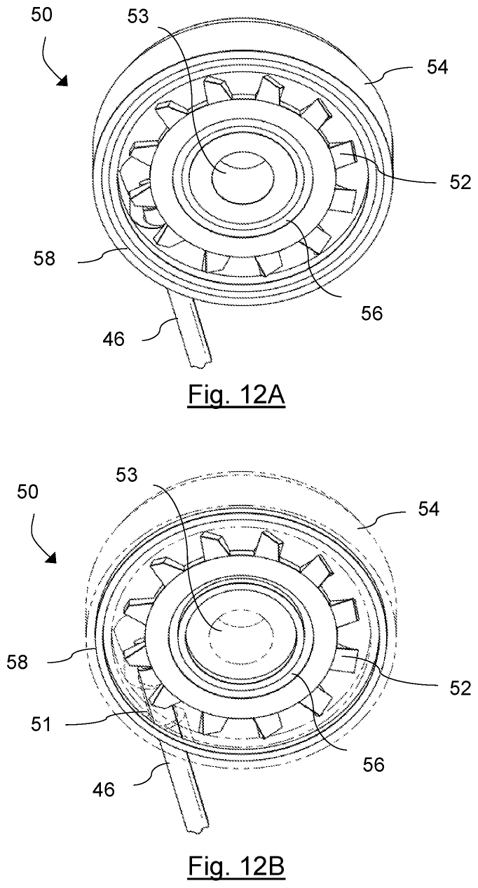

Shown in FIGS. 12A & 12B are bottom perspective views of the same alternate embodiment of the connector assembly 50. Seen from this perspective are the: ground wire 46, channel 51, washer 52, an interior socket 53, surface connector 54, and an outer insulating ring 58.

In this alternate embodiment, the conductive surface connector 54 is made from a material that will not rust to protect the components within. The ground wire 46 is coupled to the washer through the channel of the surface connector 51. The conductive disk 52 in this non-limiting example is in the shape of a star-washer to make a secure connection with the surface once secured through the interior socket 53. An inner insulating ring 56 and an outer insulating ring 58 surround either side of the conductive washer 52 and can be conventional O-rings of an appropriate size. The inner insulating ring 56 and an outer insulating ring 58 create a hermetically sealed chamber around the washer 52 with the chassis 30 when the surface connector 54 is attached to the chassis 30.

Those skilled in the art will recognize that the embodiment provided above of the connector assembly 50 is for illustrative purposes and many different materials or configurations can be used to achieve a similar result. For example, in this non-limiting example, conventional O-rings create the inner 56 and exterior 58 rings to seal the connector assembly 50 once attached. Many other materials, methods, and configurations can be utilized to achieve a similar result as will be discussed in another non-limiting example. Additionally, the conductive disk 52 can be several geometries and material to create a secure connection with the chassis of the vehicle.

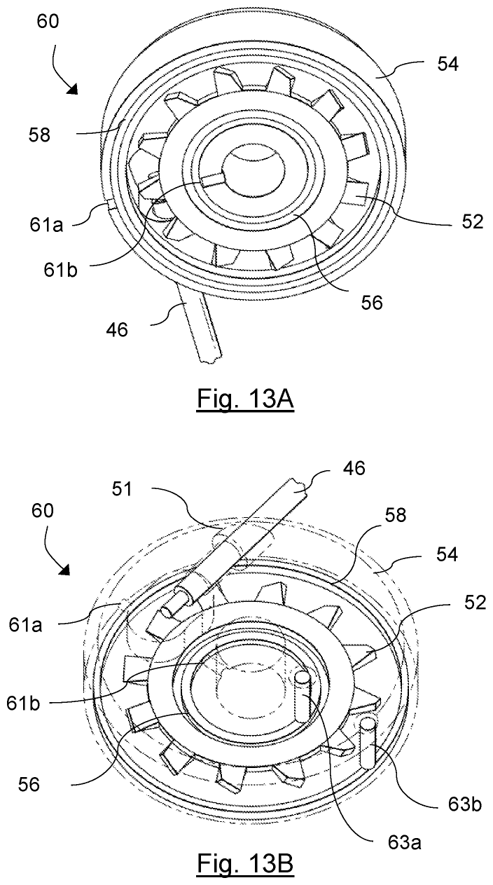

Shown in FIGS. 13A & 13B are top perspective views of another alternate embodiment of the connector assembly 60 that utilizes a conductive washer 52 sealed with a liquid sealant. Similar to the previous example, the connector assembly 10 has a ground wire 46, channel 51 for the wire to pass through the surface connector 54, washer 52, inner insulating ring 56, and outer insulating ring 58. Additionally, the surface connector includes air vents 61a & 61b and liquid inlets 63a & 63b.

In this embodiment, a liquid sealant is injected into the liquid inlets 63a & 63b and air during the injection process is expelled through the air vents 61a & 61b. Injecting the liquid sealant is typically done after the assembly 60 is installed but can also be done prior to installation as well. The liquid travels along paths that will fill both the inner insulating ring 56, and outer insulating ring 58. Once hardened, the liquid sealant creates a liquid tight seal around washer 52.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A connector assembly for providing electrical connection from an electrical device ground wire to a vehicle chassis ground, the connector assembly comprising:
a connection to the electrical device ground wire; and
a surface connector configured to attach to a vehicle chassis, wherein the surface connector further comprises:
an insulating cover; and
at least one conductive contact points within the insulating cover configured to selectively protrude through the insulating cover and make contact with the vehicle chassis when the connector assembly is secured to the vehicle chassis.

2. The connector assembly of claim 1, wherein the at least one conductive contact point of the surface connector is configured to pierce the outer insulating cover and contact the vehicle chassis while remaining sealed from the surroundings when the surface connector is secured to the vehicle chassis.

3. The connector assembly of claim 1, wherein the at least one conductive contact point of the surface connector is geometrically configured to prevent damage to the connector assembly during installation of the connector assembly to the vehicle chassis.

4. The connector assembly of claim 1, wherein the surface connector further comprises of at least one tab, wherein the at least one tab is configured to distribute the force of installation of the surface connector.

5. The connector assembly of claim 1, wherein the insulating cover substantially covers the surface connector and configured to protect the surrounding area of the at least one of conductive contact point when the surface connector is secured to the vehicle chassis.

6. The connector assembly of claim 1, wherein the insulating cover comprises a material that resists oxidation and corrosion.

7. The connector assembly of claim 1, wherein the surface connector is configured to receive a fastener to secure the connector assembly to the vehicle chassis.

8. The connector assembly of claim 1, wherein the surface connector is further configured to clamp onto an edge of the vehicle chassis.

9. The connector assembly of claim 8, wherein the surface connector is further configured to be the sole means of attachment to a vehicle chassis.

10. The connector assembly of claim 1, wherein the connection to the electrical device ground wire comprises a wire connector coupled to the surface connector configured to receive the electrical device ground wire or cable.

11. A connector assembly for providing electrical connection from an electrical device ground wire to a vehicle chassis ground, the connector assembly comprising:
a connection to the electrical device ground wire;
an insulating cover; and
a surface connector coupled to the connection to the electrical device ground wire and configured to attach to a vehicle chassis, wherein the surface connector further comprises:
at least one conductive contact point within the insulating cover configured to selectively protrude through the insulating cover and make contact with the vehicle chassis when secured to the vehicle chassis.

12. The connector assembly of claim 11, wherein the insulating cover is configured to protect the connection to the electrical device ground wire.

13. The connector assembly of claim 11, wherein the surface connector is further configured to clamp onto an edge of the vehicle chassis.

14. The connector assembly of claim 13, wherein the surface connector is further configured to be the sole means of attachment to a vehicle chassis.

15. The connector assembly of claim 13, wherein the at least one conductive contact point of the surface connector is geometrically configured to prevent damage to the connector assembly during installation of the connector assembly to the vehicle chassis.

16. The connector assembly of claim 13, wherein the surface connector further comprises of at least one tab, wherein the at least one tab is configured to distribute the force of installation of the surface connector.

17. A connector assembly for providing electrical connection from an electrical device ground wire to a vehicle chassis ground, the connector assembly comprising:
a connection to the electrical device ground wire; and
a surface connector made from a conductive material that does not oxidize, the surface connector further comprising:
a conductive washer electrically coupled to the electrical device ground wire;
a spaced apart circumferential inner edge defining a central opening configured to receive a fastener which attaches the surface connector to a chassis of a vehicle;
an outer insulating ring positioned around the outer circumferential edge of the conductive washer;
an inner insulating ring positioned within the inner circumferential edge of the conductive washer; and
wherein the inner insulating ring, the outer insulating ring form a sealed chamber with the chassis when the surface connector is attached to the chassis.

18. The connector assembly of claim 17, wherein the inner insulating ring and outer insulating ring are O-rings.

19. The connector assembly of claim 17, wherein the surface connector further comprises one or more inlets in which a liquid sealant can be injected into to form the inner insulating ring and outer insulating ring once hardened.

20. The connector assembly of claim 17, wherein the connection to the electrical device ground wire is inserted through a channel in the surface connector.
